(19) United States
(12) Patent Application Publication
(10) Pub. No.: US 2007/0251589 A1
(43) Pub. Date: Nov. 1, 2007

(54) VALVE MECHANISM AND FLOW CHANNEL SUBSTRATE

(75) Inventor: TORU KAJI, KYOTO (JP)

Correspondence Address: J C PATENTS, INC., 4 VENTURE, SUITE 250, IRVINE, CA, 92618, US

(73) Assignee: SHIMADZU CORPORATION, KYOTO (JP)

(21) Appl. No.: 11/624,890

(22) Filed: Jan. 19, 2007

(30) Foreign Application Priority Data
May 1, 2006 (JP) 2006-127318

(51) Int. Cl. F16K 11/07

(52) U.S. Cl. 137/625.48

(57) ABSTRACT

A valve mechanism is provided, which can be embedded in a flow channel substrate without adding complexity of structure of the flow channel substrate. A rectangular space, i.e. a valve chamber, is formed in a flow channel substrate (1). Flow channels (2a, 2b, 2c) are connected to the valve chamber from different directions. The flow channels (2a, 2b) are connected respectively to a first surface and a second surface, opposite to the first surface, of the valve chamber. The flow channel (2c) is connected to a third surface different from the first and the second surfaces. A valve body 8 is accommodated in the valve chamber 4. The valve body slides between the first and the second surfaces in the valve chamber. On the sides of the first and the second surfaces outside the valve chamber, electromagnets are buried in the flow channel substrate (1) to sandwich the valve chamber.

### CROSS-REFERENCE TO RELATED APPLICATION

This application claims the priority benefit of Japan application serial no. 2006-127318, filed May 1, 2006. All disclosure of the Japan application is incorporated herein by reference.

### BACKGROUND OF THE INVENTION

1. Field of the Invention

The present invention relates to a valve mechanism for switching on or off a fluid in a flow channel, or selectively switching the connected flow channel. More particularly, the present invention relates to a valve mechanism embedded in a flow channel substrate such as a microchip or a capillary plate, and a flow channel substrate with the valve mechanism embedded therein.

2. Description of Related Art

In order to realize a multifunction of a substrate with microchannels formed therein so as to achieve a high level of integration, a valve mechanism for controlling the fluid flowing in the flow channels is required to be embedded in the flow channel substrate itself. However, not only it is difficult to embed the valve mechanism in the flow channel substrate, the structure of the flow channel substrate itself will generally become complicated. If the structure of the flow channel substrate becomes complicated, the number of procedures for fabricating the flow channel substrate must increase, which lead to the increase of cost.

Several methods of embedding a valve mechanism in a flow channel substrate have been proposed (for example, please refer to Reference 1 and Reference 2).

The valve mechanism disclosed in Reference 1 uses a working fluid filled in a pressurized slot disposed between opposite electrodes to compress an elastic and deformable film that forms a part of a flow channel disposed in the substrate, so as to obstruct the flowing of the fluid in the flow channel. In other words, the valve mechanism uses the working fluid to indirectly control the opening/closing of the flow channel by applying a voltage between the electrodes.

Moreover, a method of using gas pressure to indirectly control the open/close of a micro valve in a micro reactor is disclosed in Reference 2.

Reference 1: Japan Laid-Open Patent Publication No. 2004-291187

Reference 2: Japan Laid-Open Patent Publication No. 2004-361205

### SUMMARY OF THE INVENTION

The present invention is directed to providing an embedded valve mechanism that can be directly controlled without adding complexity to the structure of a flow channel substrate.

A configuration of the valve mechanism of the present invention comprises a valve chamber, to which a plurality of flow channels formed in a substrate is connected; a valve body, slidably disposed in the valve chamber and comprising a magnet for switching connection between the flow channels; and an electromagnetic portion, for driving the valve body to move by means of an electromagnetic force.

Moreover, another configuration of the valve mechanism of the present invention comprises a valve chamber, disposed in a flow channel and having a wall formed by a deformable material; a valve body, disposed on the wall and comprising a magnet for opening or closing the flow channel; and an electromagnetic portion, urging the valve body to move in a direction that the flow channel is opened or closed by means of an electromagnetic force.

The deformable material forming a wall described above is an elastic material, for example, polydimethylsiloxane (PDMS).

The flow channel substrate of the present invention integrates a plurality of flow channels and the valve mechanism of the present invention.

As the valve mechanism of the present invention directly drives the valve body comprising the magnet by means of the electromagnetic force, the response is good, and the valve mechanism of the present invention can be embedded in the flow channel substrate without adding complexity to the structure of the flow channel substrate.

As the flow channel substrate of the present invention integrates a plurality of flow channels and the valve mechanism of the present invention, the flow channel substrate has multiple functions, and a high level of integration can be achieved.

### BRIEF DESCRIPTION OF THE DRAWINGS

FIGS. 1(A) and (B) are schematic views of the valve mechanism in the flow channel substrate according to an embodiment, in which FIG. 1(A) is a plan view, and FIG. 1(B) is a sectional view taken along line A-A of FIG. 1(A).

FIG. 2 is a schematic view of the valve mechanism in the flow channel substrate according to another embodiment.

FIGS. 3(A) and (B) are schematic views of the valve mechanism in the flow channel substrate according to another embodiment, in which FIG. 3(A) shows the state when the flow channels are opened, and FIG. 3(B) shows the state when the flow channels are closed.

### DESCRIPTION OF EMBODIMENTS

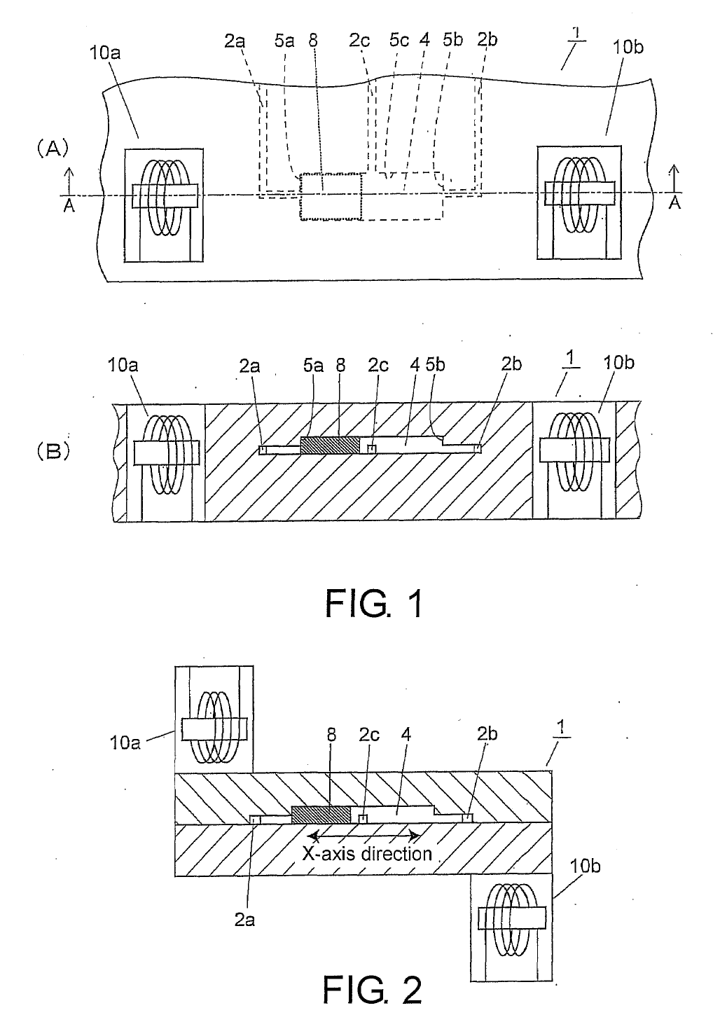

FIGS. 1(A) and (B) are schematic views of the valve mechanism in the flow channel substrate according to an embodiment, in which FIG. 1(A) is a plan view, and FIG. 1(B) is a sectional view taken along line A-A of FIG. 1(A).

A rectangular space, i.e., a valve chamber 4, is formed in a flow channel substrate 1. Flow channels 2a, 2b, and 2c are connected to the valve chamber 4 from different directions. The flow channels 2a and 2b are connected respectively to a first surface 5a and a second surface 5b, opposite to the first surface 5a, of the valve chamber 4. The flow channel 2c is connected to a third surface 5c different from the first surface 5a and the second surface 5b.

A valve body 8 is accommodated in the valve chamber 4. The valve body 8 slides between the first surface 5a and the second surface 5b in the valve chamber 4. The valve body 8 is formed by a magnetic material such as Fe, Cu, or Ni, or resin, and a magnet or magnetic particles are buried in the valve body 8. The position of the flow channel 2c and the size of the valve body 8 are set, such that the flow channel 2c will not be closed by the valve body 8 no matter the valve body 8 moves to the first surface 5a or to the second surface 5b.

On the sides of the first surface 5a and the second surface 5b outside the valve chamber 4, electromagnets 10a and 10b serving as an electromagnetic portion are buried in the flow channel substrate 1 to sandwich the valve chamber 4.

By means of the magnetic field generated by the electromagnet 10a, the valve body 8 is moved to the surface 2a in the valve chamber 4, and by means of the magnetic field generated by the electromagnet 10b, the valve body 8 is moved to the surface 2b in the valve chamber 4.

If only the electromagnet 10a is powered, the electromagnet 10a generates a magnetic field, causing the valve body 8 to move to the surface 2a, and thus closing the flow channel 2a. At this time, the remaining two flow channels 2b and 2c are in an open state, and the two flow channels 2b and 2c are connected.

Moreover, if only the electromagnet 10b is powered, the valve body 8 moves to the surface 2b due to a magnetic field generated by the electromagnet 10b, and thus closing the flow channel 2b. At this time, the remaining two flow channels 2a and 2c are in an open state, and the two flow channels 2a and 2c are connected.

In this embodiment, by controlling the ON/OFF of the electromagnets 10a and 10b disposed on the sides of the valve chamber 4, only the flow channel 2a or 2b formed in the flow channel substrate 1 is closed, and the remaining two flow channels are connected. Therefore, the flow channels connected by the magnetic field generated by the electromagnet 10a or 10b can be switched directly, thereby having a good response. In addition, as the structure of the valve mechanism only includes the valve body 8 accommodated in the valve chamber 8 and the electromagnets 10a and 10b, the valve mechanism can be directly embedded in the flow channel substrate 1 without adding complexity to the structure of the flow channel substrate 1.

Here, in this embodiment, the electromagnets 10a, 10b are configured to sandwich the flow channel substrate 1. Further, it is also possible to allow the electromagnets 10a, 10b to generate magnetic fields in the direction that the valve body 8 slides. For example, as shown in FIG. 2, the electromagnets 10a, 10b can also be configured to be oblique relative to the valve chamber 4. Here, an electromagnet is disposed on the surface side, and the other electromagnet is disposed on the back side, or the two electromagnets are both disposed on the same side. In this circumstance, the electromagnets 10a and 10b, as long as being attached on the surface or back side of the substrate, are not required to be buried in the substrate 1.

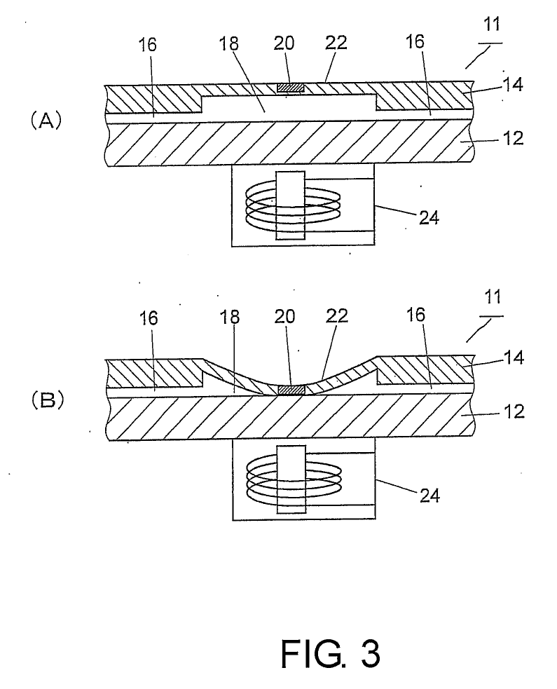

In addition, another embodiment of the valve mechanism embedded in the flow channel substrate will be described. FIGS. 3(A) and (B) are schematic views of the valve mechanism in the flow channel substrate according to another embodiment, in which FIG. 3(A) shows the state when the flow channels are opened, and FIG. 3(B) shows the state when the flow channels are closed.

A flow channel 16 is formed in a flow channel substrate 11. The flow channel substrate 11 is formed by overlapping a PDMS substrate 14 on a glass substrate 12. A rectangular space, i.e., a valve chamber 18, is formed in the middle of the flow channel 16. The valve chamber 18 is formed on the PDMS substrate 14 by pressing, and the PDMS substrate 14 in the portion where the valve chamber 18 is formed is thinner than in other portions. The thin portion of the PDMS substrate 14 forms a wall 22 of the valve chamber 18. As shown in FIG. 3(B), the wall 22 has elastic deformation, and is bent to the opposite surface, i.e., the side of the glass substrate 12, in the valve chamber 18. A magnet 20 is buried in the portion that forms the wall 22 of the PDMS substrate 14.

An electromagnet 24 is disposed below the glass substrate 12, in which the electromagnet 24 functions as an electromagnetic portion that generates a downward magnetic field. If the downward magnetic field is generated in the valve chamber 18, the magnet 20 buried in the wall 22 causes the wall 22 to bend and meanwhile moves to the side of the glass substrate 12, such that the wall 22 contacts the glass substrate 12.

In other words, as for the valve mechanism of this embodiment, if the electromagnet 24 is powered, under the effect of the downward force of the magnetic field generated by the electromagnet 24, the magnet 20 causes the wall 22 to bend and meanwhile moves towards the side of the glass substrate 12. Thus, after the valve chamber 18 obstructs the flow channel 16, the flow channel 16 is closed. When a voltage is not applied on the electromagnet 24, the bent wall 22 is restored to the state shown in FIG. 3(A) by means of the restoring force generated from the elasticity of the PDMS, so as to open the flow channel 16.

Thus, the valve mechanism of this embodiment can control the opening/closing of the flow channel 16 by controlling the ON/OFF of the electromagnet 24. Accordingly, the valve mechanism also directly controls the opening/closing of the flow channel 16 with the electromagnet 24, and a good response is resulted. In addition, as the valve mechanism includes the valve chamber 18, the magnet 20, and the electromagnet 24 driving the magnet 20, the structure of the flow channel substrate 11 will not become complicated. The valve chamber 18 has the wall 22 formed by a deformable material such as PDMS etc., and the magnet 20 is buried in the portion that forms the wall 22 of the PDMS substrate 14.

In this embodiment, the magnet 20 is buried in the portion that forms the wall 22 of the PDMS substrate 14. However, the present invention is not limited to the above, and the magnet 20 can also be mounted above the portion that forms the wall 22 of the PDMS substrate 14.

In addition, in this embodiment, the restoring force of PDMS is used to turn the flow channel 16 from a close state to an open state. However, the present invention is not limited to the above. The electromagnet can also be disposed above the PDMS substrate, and an upward magnetic field generated by the electromagnet can be used to enable the magnet 20 buried in the wall 22 to move upward. In addition, a spring mechanism can also be mounted, and the elastic force of the spring can be used to open the flow channel 16.

What is claimed is:

1. A valve mechanism, comprising:
a valve chamber, to which a plurality of flow channels formed in a substrate is connected;
a valve body, slidably disposed in the valve chamber and comprising a magnet for switching a connection between the flow channels; and
an electromagnetic portion, for driving the valve body to move by an electromagnetic force.

2. A valve mechanism, comprising:
a valve chamber, disposed in a flow channel and having a wall formed by a deformable material;
a valve body, disposed on the wall and comprising a magnet for opening or closing the flow channel; and
an electromagnetic portion, urging the valve body to move in a direction that the flow channel is opened or closed by an electromagnetic force.

3. The valve mechanism as claimed in claim 2, wherein the deformable material is an elastic material.

4. A flow channel substrate, integrating a plurality of flow channels and the valve mechanism as claimed in claim 1.

5. A flow channel substrate, integrating a plurality of flow channels and the valve mechanism as claimed in claim 2.

6. A flow channel substrate, integrating a plurality of flow channels and the valve mechanism as claimed in claim 3.

7. The valve mechanism as claimed in claim 1, wherein the valve mechanism is embedded in a flow channel substrate without adding complexity to the structure of the flow channel substrate.

8. The valve mechanism as claimed in claim 2, wherein the valve mechanism is embedded in a flow channel substrate without adding complexity to the structure of the flow channel substrate.

9. The flow channel substrate as claimed in claim 4, wherein the flow channel substrate has multiple functions for achieving a high level of integration.

10. The flow channel substrate as claimed in claim 5, wherein the flow channel substrate has multiple functions for achieving a high level of integration.

11. The flow channel substrate as claimed in claim 6, wherein the flow channel substrate has multiple functions for achieving a high level of integration.

12. The flow channel substrate as claimed in claim 4, wherein a flow channel is formed in the flow channel substrate, and the flow channel substrate is formed by overlapping a PDMS substrate on a glass substrate.

13. The flow channel substrate as claimed in claim 5, wherein a flow channel is formed in the flow channel substrate, and the flow channel substrate is formed by overlapping a PDMS substrate on a glass substrate.

14. The flow channel substrate as claimed in claim 6, wherein a flow channel is formed in the flow channel substrate, and the flow channel substrate is formed by overlapping a PDMS substrate on a glass substrate.

15. The flow channel substrate as claimed in claim 12, wherein the valve chamber as a rectangular space is formed in a middle of the flow channel.

16. The flow channel substrate as claimed in claim 13, wherein the valve chamber as a rectangular space is formed in a middle of the flow channel.

17. The flow channel substrate as claimed in claim 14, wherein the valve chamber as a rectangular space is formed in a middle of the flow channel.

18. The flow channel substrate as claimed in claim 15, wherein the valve chamber is formed on the PDMS substrate by pressing, and a part of the PDMS substrate where the valve chamber is formed is thinner than other parts.

19. The flow channel substrate as claimed in claim 16, wherein the valve chamber is formed on the PDMS substrate by pressing, and a part of the PDMS substrate where the valve chamber is formed is thinner than other parts.

20. The flow channel substrate as claimed in claim 17, wherein the valve chamber is formed on the PDMS substrate by pressing, and a part of the PDMS substrate where the valve chamber is formed is thinner than other parts.
